(19) United States
(12) Patent Application Publication
(10) Pub. No.: US 2010/0112428 A1
(43) Pub. Date: May 6, 2010

(54) POWER SUPPLY APPARATUS

(76) Inventor: Izumi Takahashi, Toyota-shi (JP)

Correspondence Address: KENYON & KENYON LLP, 1500 K STREET N.W., SUITE 700, WASHINGTON, DC, 20005, US

(21) Appl. No.: 12/527,807

(22) PCT Filed: Feb. 19, 2008
(86) PCT No.: PCT/IB08/00375

§ 371 Date: Aug. 19, 2009

(30) Foreign Application Priority Data
Feb. 20, 2007 (JP) 2007-038884

(51) Int. Cl. H01M 10/50

(52) U.S. Cl. 429/120

(57) ABSTRACT

A power supply apparatus in which an assembled battery and coolant that cools the assembled battery are housed in a battery case is structured such that an endless belt is arranged in the coolant and the coolant is circulated by endlessly rotating the endless belt. The endless belt is arranged so as to surround the assembled battery. Circulation fins are provided on the endless belt. As a result, a variation in temperature distribution of the coolant can be suppressed and the power supply apparatus can be made smaller.

### BACKGROUND OF THE INVENTION

1. Field of the Invention

The invention relates to a power supply apparatus in which a power supply element and coolant for cooling the power supply element are housed inside a power supply case.

2. Description of the Related Art

If a power supply (such as a secondary battery or a fuel cell) for driving a vehicle such as a hybrid vehicle, an electric vehicle, or a fuel cell vehicle or the like exceeds a suitable temperature, gas is produced by the cell element. Therefore, the power supply must be quickly cooled when heat is generated.

Japanese Patent No. 2959298 describes technology for cooling coolant. According to this technology, coolant is filled into a box-shaped container in which a plurality of unit cells are housed. This coolant is then circulated using a circulating device provided near an outer peripheral portion of the box-shaped container.

Also, Japanese Patent Application Publication No. 2005-19134 (JP-A-2005-19134) describes a method for circulating coolant, which has been filled inside a fuel cell container that houses a lead battery, between the inside and outside of the container using a pressure pump.

Also, Japanese Patent No. 2775600 describes a related cooling apparatus which includes an insulated housing and a cooler which is arranged inside this insulated housing and through which air flows. The cooler is formed by arranging a plurality of plate-shaped cooling elements parallel with each other. Battery cells to be cooled are arranged in the spaces between these parallel cooling elements.

Further, Japanese Patent Application Publication No. 9-266016 (JP-A-9-266016) describes a method for cooling a cylindrical cell. According to this technology, the cylindrical cell is retained by a case that contacts an outer peripheral surface of the cylindrical cell. The cylindrical cell is cooled by supplying cooling fluid through a passage that extends through the inside of the case.

Also, a pamphlet of International Publication 98/32186 describes a battery module in which a plurality of unit cells and fluid that has an electrical insulating property are housed inside an insulated container, and coolant is circulated between the inside and outside of the insulated container using a pump.

Moreover, Japanese Patent Application Publication No. 11-307139 (JP-A-11-307139) describes a battery cooling apparatus in which coolant having an electrical insulating property is filled inside a sealed container that houses a battery. A cooling conduit through which a cooling medium that cools coolant is also arranged within the sealed container.

However, with the structure of the technology described in Japanese Patent No. 2959298, the circulating device is provided near an outer peripheral portion of the box-shaped container so the area where circulation takes place is limited and the temperature of the coolant as a whole is not able to be made uniform. As a result, unit cells that are farther from the circulating device may not be sufficiently cooled.

Even if a plurality of circulating members were provided, circulation would still be insufficient in those areas where a circulating member was not provided, and the increase in the number of circulating members would increase costs.

In addition, with the method for forcibly circulating coolant, a circulation passage and a forced circulation pump need to be provided outside the battery container, which may increase the size of the overall apparatus.

### SUMMARY OF THE INVENTION

This invention thus provides a power supply apparatus capable of suppressing variation in the temperature distribution of coolant.

A first aspect of the invention relates to a power supply apparatus in which a power supply element and coolant that cools the power supply element are housed in a power supply case. This power supply apparatus includes an endless belt that is arranged in the coolant, and rotating means for endlessly rotating the endless belt.

Here, the power supply element may be arranged in a region surrounded by the endless belt. Also, a plurality of circulation portions may be provided on the endless belt.

The power supply apparatus may also be provided with temperature detecting means for detecting a temperature of the coolant, and rotation controlling means for controlling rotation of the endless belt by the rotating means based on a detection result from the temperature detecting means.

The power supply element may be formed of a plurality of power supply bodies. In this case, the power supply element may be formed by arranging the power supply bodies parallel with each other between support members, and a bearing portion of a rotating shaft of the rotating means may be formed on the support members.

The power supply apparatus may also include a magnetic motor for rotating the rotating shaft from outside the power supply case.

According to the invention, coolant is circulated by endlessly rotating the endless belt in the coolant so variation in the temperature distribution of the coolant can be suppressed.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view in the Y-Z planar direction of a power supply apparatus 1 (i.e., in the length direction of a battery) according to a first example embodiment of the invention;

FIG. 2 is a sectional view taken along line I-I′ in FIG. 1;

FIG. 3 is a sectional view taken along line II-II′ in FIG. 1;

FIG. 4 is a sectional view of a rotational driving portion that rotates a rotating shaft;

FIG. 5 is a block diagram of a rotation control portion (i.e., rotation controlling means) that controls the rotation of an endless belt;

FIG. 6 is a flowchart illustrating a method for rotatably driving the endless belt; and

FIG. 7 is a sectional view of a power supply apparatus 1′ according to a second example embodiment of the invention.

### DETAILED DESCRIPTION OF EMBODIMENTS

Hereinafter, example embodiments of the invention will be described.

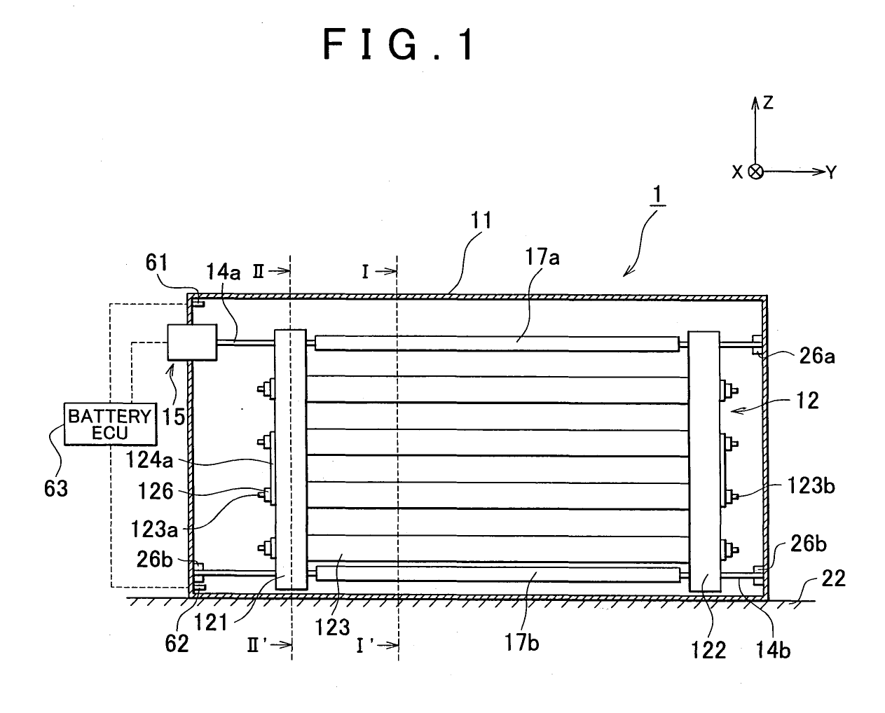

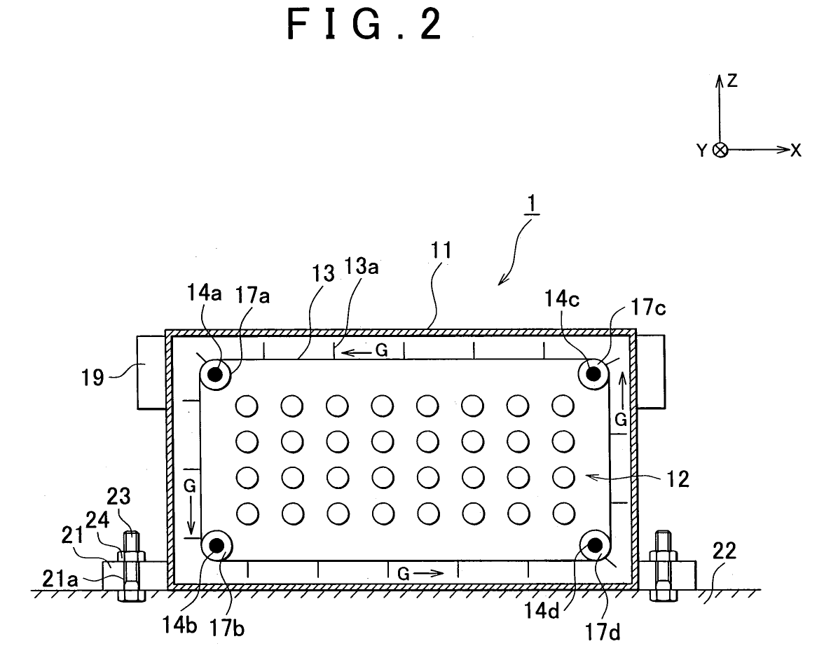

The general structure of the invention will now be described with reference to FIGS. 1 and 2. FIG. 1 is a sectional view in the Y-Z planar direction of a power supply apparatus 1 (i.e., in the length direction of a battery) according to a first example embodiment of the invention, and FIG. 2 is a sectional view taken along line I-I′ in FIG. 1.

The power supply apparatus 1 of the invention includes a battery case (i.e., a power supply case) 11 that is filled with coolant, an assembled battery (i.e., a power supply element) 12 arranged in the coolant, and an endless belt 13 arranged in the coolant and surrounding the assembled battery 12. The endless belt 13 is omitted in FIG. 1.

Belt drive rollers (i.e., rotating means) 17a to 17d that rotate around rotating shafts 14a to 14d, respectively, are in pressure-contact with four corners of the endless belt 13 such that the endless belt 13 is able to be rotated endlessly by rotating the belt driving rollers 17a to 17d.

Endlessly rotating the endless belt 13 circulates coolant inside the battery case 11, thereby enabling the temperature of the coolant to be uniform (i.e., enabling variation in the temperature distribution to be suppressed). As a result, the life of the assembled battery 12 can be extended.

Also, arranging the endless belt 13 so that it surrounds the entire assembled battery 12 enables all of the coolant to be circulated. Thus, it is no longer necessary to provide a plurality of circulating devices to circulate all of the coolant so costs can be reduced.

Moreover, the circulating means (i.e., the endless belt 13) is arranged in the coolant so the power supply apparatus 1 can be made smaller than it can be with a structure in which the coolant is circulated by a circulation pump.

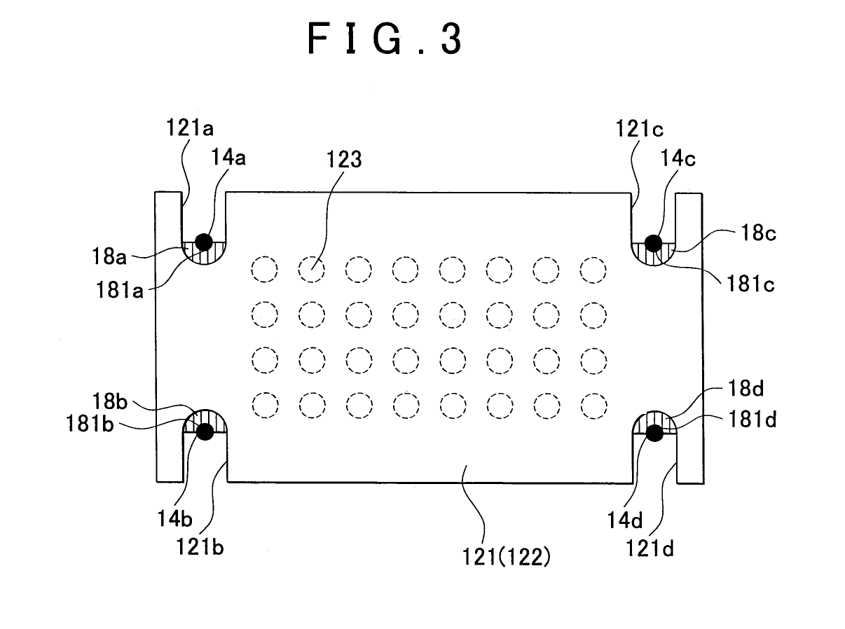

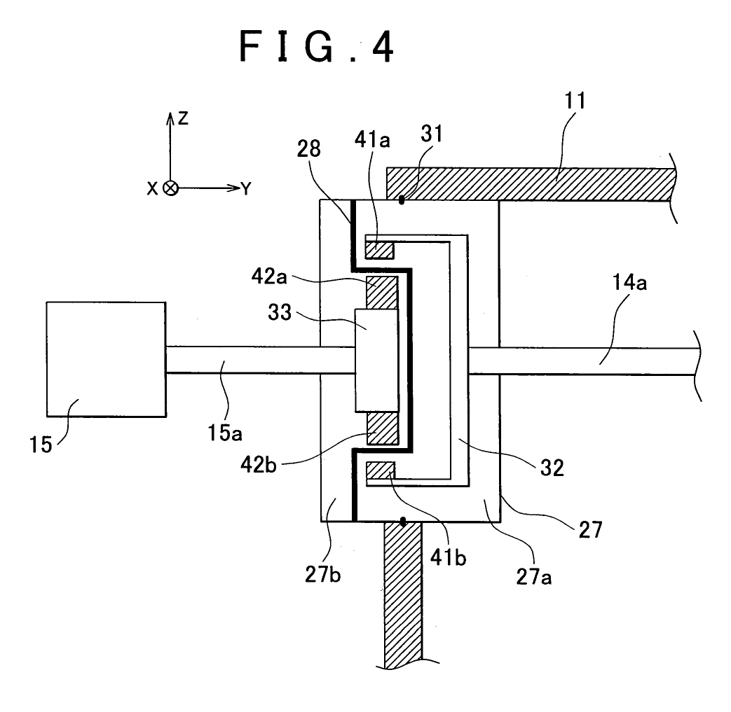

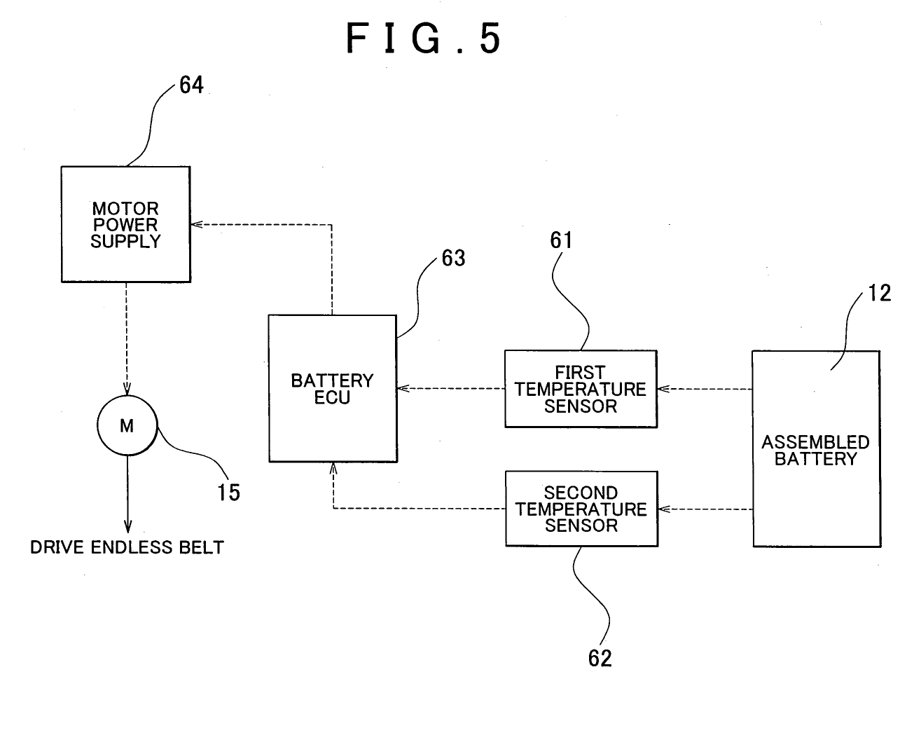

Next, the structure of the power supply apparatus 1 will be described in detail with reference to FIGS. 1 to 5. FIG. 3 is a sectional view taken along line II-II′ in FIG. 1, FIG. 4 is a sectional view of a rotational driving portion that rotates the rotating shaft 14a, and FIG. 5 is a block diagram of a rotation control portion (i.e., rotation controlling means) that controls the rotation of the endless belt 13. In FIG. 5, the solid line denotes a mechanical connection and the broken lines denote electrical connections.

As shown in FIG. 1, the assembled battery 12 is formed by a plurality of cylindrical cells (i.e., cylindrical power supply bodies) 123 arranged parallel with one another between a pair of cell holders (supporting members) 121 and 122 that are arranged facing one another.

A screw shaft portion 123a is arranged on one end of each cylindrical cell 123 and a screw shaft portion 123b is arranged on the other end of each cylindrical cell 123. A plurality of insertion hole portions, not shown, into which the screw shaft portions 123a and 123b of each cylindrical cell 123 are inserted are formed in a matrix in the cell holders 121 and 122. When the cylindrical cells 123 are in an assembled state, the screw shaft portions 123a and 123b protrude from the insertion hole portions to the outside of the cell holders 121 and 122. Incidentally, the cell holders 121 and 122 are made of insulating resin.

When a plurality of cylindrical cells 123 are assembled together to create a battery assembly, there may be variation in the temperature of the heat produced by the cylindrical cells 123. For example, a cylindrical cell 123 that is arranged toward the center of the battery assembly may produce heat of a higher temperature than the heat produced by a cylindrical cell 123 that is arranged toward the outside of the battery assembly. As a result, the cylindrical cell 123 toward the center may deteriorate faster than the cylindrical cell 123 toward the outside. To counteract this, variation in the temperature of the cylindrical cells 123 may be quickly suppressed by forcefully circulating coolant.

As shown in FIG. 3, a notch portion 121a to 121d is provided near each of the four corners of the cell holder 121, and a bearing portion 18a to 18d, which is indicated by hatching, is provided in each notch portion 121a to 121d.

An R-shaped bearing surface 181a to 181d is formed on each bearing portion 18a to 18d, respectively. Each bearing surface 181a to 181d rotatably supports one of the rotating shafts 14a to 14d.

Forming the bearing portions on the cell holder 121 in this way obviates the need for independent bearing members and makes it easier to arrange the assembled battery 12 and to position a motor 15. Incidentally, the cell holder 122 has the same structure as the cell holder 121.

A bus bar 124 connects adjacent cylindrical cells 123 together in series. This bus bar 124 fits onto the screw shaft portions 123a and 123b. The cylindrical cells 123 can then be fixed to the cell holders 121 and 122 by screwing fastening nuts 126 onto the screw shaft portions 123a and 123b over the bus bar 124.

Next, the structure of the battery case 11 will be described in detail. As shown in FIG. 2, a cooling fin 19 for dissipating heat produced by the assembled battery 12 that is transmitted by the coolant, as well as a mounting bracket 21 for fixing the battery case 11 to a floor panel 22 beneath the passenger's seat, are formed on the outer peripheral surface of the battery case 11. Incidentally, the cooling fin 19 may also be provided in plurality.

An open portion 21a that extends vertically is formed in the mounting bracket 21. A fastening bolt 23 is inserted into this open portion 21a from the floor panel 22 side.

A tip portion of the fastening bolt 23 protrudes from the mounting bracket 21. The power supply apparatus 1 can be fixed to the floor panel 22 by screwing a fastening nut 24 onto the fastening bolt 23 from inside the vehicle cabin. Incidentally, the battery case 11 may be made of metal or resin, for example.

A first temperature sensor 61 and a second temperature sensor 62 are provided on the inner peripheral surface of the battery case 11. The first temperature sensor 61 is arranged above the assembled battery 12 and the second temperature sensor 62 is arranged below the assembled battery 12. Here, coolant that is hot from cooling the assembled battery 12 naturally rises due to the difference in the specific gravity of the surrounding coolant.

Therefore, variation in the temperature of the coolant can be accurately measured by arranging the temperature sensors 61 and 62 above and below the assembled battery 12.

As shown in FIG. 5, the first and second temperature sensors 61 and 62 are electrically connected to a battery ECU 63.

The battery ECU 63 switches a motor power supply 64 on when the temperature difference of the coolant is 5° C. or more based on the temperature information output from the first and second temperature sensors 61 and 62, and switches the motor power supply 64 off when the temperature difference of the coolant is less than 5° C.

Next, the structure of the endless belt 13 will be described in detail. The inside surface of the endless belt 13 faces the surface of the cylindrical cells 123 in the length direction and surrounds the assembled battery 12 in the coolant.

A plurality of circulation fins (i.e., circulation portions) 13a which extend in the direction of thickness of the belt are provided at predetermined intervals (pitches) on the outer surface of the endless belt 13. Providing these circulation fins 13a promotes the circulation of the coolant. Incidentally, the circulation portions may also be formed by forming asperities (i.e., convex and concave portions) on the surface of the endless belt 13.

Also, belt driving rollers 17a to 17d are in pressure-contact with the four corners of the endless belt 13 from the inside of the endless belt 13. The belt driving rollers (i.e., rotating means) 17a to 17d are formed in cylindrical shapes, with each having a rotating shaft (i.e., rotating means) 14a to 14d, respectively, at the inner radial portion. Each belt driving roller 17a to 17d rotates together as a single unit with its respective rotating shaft 14a to 14d.

Pairs of left and right radial bearing portions 26b to 26d are provided on an inside wall portion of the battery case 11 in FIG. 1. The pairs of radial bearings 26b to 26d rotatably support the rotating shafts 14b to 14d.

Next, the structure for rotating the rotating shaft 14a will be described with reference to FIGS. 1 to 4.

A radial bearing portion 26a that has the same structure as the radial bearing portions 26b to 26d is provided on an inside wall portion of the battery case 11 in the axial direction of the rotating shaft 14a. This radial bearing portion 26a rotatably supports the rotating shaft 14a.

Furthermore, a rotating plate accommodating portion 27 that has an accommodating space with dimensions (in the Y axis direction) greater than the thickness of the battery case 11 is provided in a wall portion of the battery case 11, and an oil seal 31 is interposed at the boundary where the rotating plate accommodating portion 27 meets the wall portion of the battery case 11.

This oil seal 31 makes it possible to reliably seal the coolant inside the battery case 11.

The rotating plate accommodating portion 27 is vertically divided into two chambers, i.e., a first rotating plate accommodating portion 27a which is on the right side in the drawing and a second rotating plate accommodating portion 27b which is on the left side in the drawing, by a hat-shaped dividing wall 28. The other end portion of the rotation shaft 14a extends out into the first rotating plate accommodating portion 27a. An output shaft 15a of the motor (i.e., rotating means) 15 extends out into the second rotating plate accommodating portion 27b.

A rotating plate 32 which is shaped like a cylinder that is closed off at one end is fixed to the other end portion of the rotating shaft 14a. A plurality of magnets 41a that have a N pole on the outside and a plurality of magnets 41b that have an S pole on the outside are alternately arranged in the circumferential direction on the inner peripheral surface of the rotating plate 32.

A disc-shaped magnet mounting plate 33 is fixed to the tip portion of the output shaft 15a of the motor 15. A plurality of magnets 42a that have a N pole on the outside and a plurality of magnets 42b that have an S pole on the outside are alternately arranged in the circumferential direction on the peripheral surface of this magnet mounting plate 33.

When the output shaft 15a of the motor 15 rotates, the magnetic action of the magnets 41a, 41b, 42a, and 42b rotates the rotating shaft 14a. Incidentally, the motor 15, the output shaft 15a, the magnet mounting plate 33, the magnets 41a, 41b, 42a, and 42b, and the rotating plate 32 together form a magnetic motor.

The magnetic motor is used in this way to rotate the endless belt 13 which circulates the coolant that is sealed within the battery case 11.

Here, the coolant that is filled in the battery case 11 may be material which has high specific heat, good heat conductivity, and a high boiling point, will not corrode the battery case 11 or the assembled battery 12, and is resistant to thermal decomposition, air oxidation, and electrolysis, and the like. Moreover, an electrically insulating liquid may be used to prevent a short between electrode terminals.

More specifically, fluorine-containing inert liquid, for example, may be used as the coolant. Examples of a fluorinated inert fluid include Fluorinert™, Novec™ HFE (hydrofluoroether), and Novec™ 1230, all from 3M Corporation. Alternatively, a liquid other than fluorinated inert fluid (such as silicon oil) may also be used.

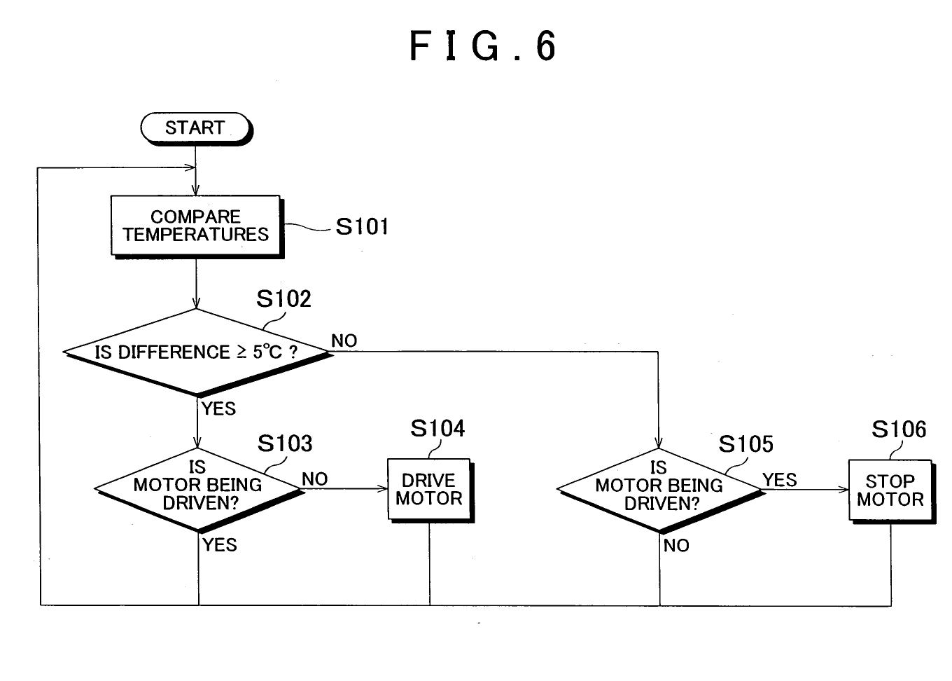

Next, a method for controlling the motor 15 will be described with reference to FIGS. 5 and 6. FIG. 6 is a flowchart illustrating a method for rotatably driving the endless belt 13. Incidentally, the routine in this flowchart is executed by the battery ECU (i.e., rotation controlling means) 63.

First, the battery ECU 63 compares the temperature information output from the first and second temperature sensors 61 and 62 (step S101), and then determines whether the temperature difference of the coolant is equal to or greater than 5° C. (step S102).

If it is determined in step S102 that the temperature difference is equal to or greater than 5° C., then the battery ECU 63 determines whether the motor power supply 64 is on (step S103). If the motor power supply 64 is not on (i.e., NO in step S103), the battery ECU 63 switches it on (step S104).

When the battery ECU 63 switches the motor power supply 64 on, the output shaft 15a of the motor 15 rotates. As a result, the magnetic action of the magnets 41a, 41b, 42a, and 42b mounted on the magnet mounting plate 33 and rotating plate 32 works to rotate the rotating shaft 14a.

As shown in FIG. 2, the endless belt 13 that is in pressure-contact with the belt driving roller 17a rotates counterclockwise (i.e., in the direction of arrow G) according to the rotation of the rotating shaft 14a. As a result, the coolant is moved along the inner peripheral wall of the battery case 11, thus enabling the temperature of the coolant to be evened out.

Also, forcibly circulating coolant quickly suppresses variation in the temperature of the cylindrical cells 123 and lowers the highest temperature of the cylindrical cells 123, thereby extending the life of the assembled battery 12.

Incidentally, if it is determined in step S103 that the motor 15 is currently being driven or the motor power supply 64 was switched on in step S104, the process returns to step S101.

If it is determined in step S102 that the temperature difference is less than 5° C., the battery ECU 63 then determines whether the motor power supply 64 is on (step S105). If the motor power supply 64 is on, the battery ECU 63 switches it off to stop the motor 15 (step S106). Incidentally, if it was determined in step S105 that the motor 15 is not currently being driven or the motor power supply 64 was switched off in step S106, the process returns to step S101.

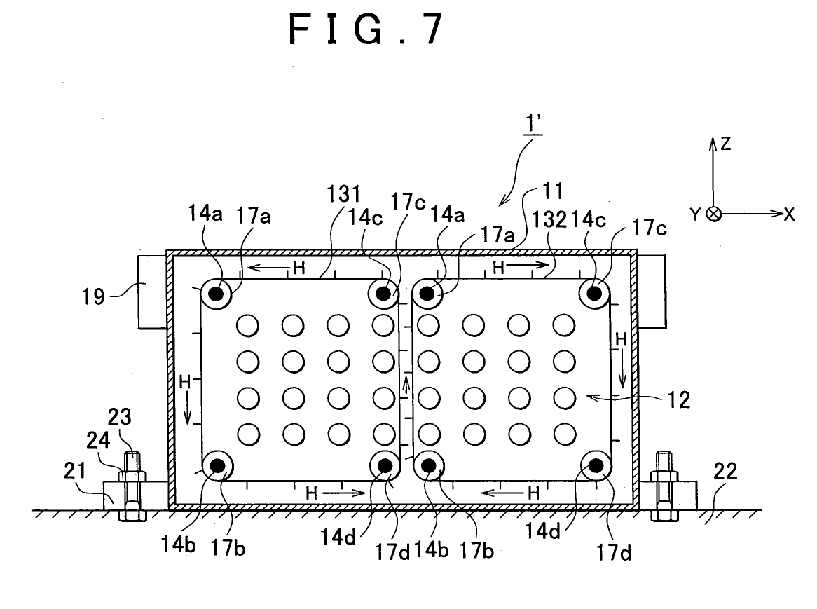

A second example embodiment of the invention will now be described with reference to FIG. 7 which is a sectional view of a power supply apparatus 1′ according to the second example embodiment.

The assembled battery 12 is formed by arranging cylindrical cells 123 in four rows in the direction of the Z axis (i.e., vertically) and eight rows in the direction of the X axis (i.e., horizontally).

A first endless belt 131 surrounds the four rows of cylindrical cells 123 on the left side and a second endless belt 132 surrounds the four rows of cylindrical cells 123 on the right side.

The first and second endless belts 131 and 132 are each independently driven by separate motors, i.e., the first endless belt 131 is driven by a first motor and the second endless belt 132 is driven by a second motor. These motors correspond to the motor 15 in the first example embodiment and are not shown in FIG. 7.

The first motor and the second motor are driven in opposite directions from each other. The first endless belt 131 is endlessly rotated in the counterclockwise direction by driving the first motor, and the second endless belt 132 is endlessly rotated in the clockwise direction by driving the second motor. As a result, coolant is circulated in the directions of arrows H.

According to the foregoing structure, coolant near the cylindrical cells 123 positioned at the center of the assembled battery 12 where a large amount of heat is produced (e.g., near the cylindrical cells 123 that are arranged in the fourth and fifth rows from the right) is able to be reliably circulated. As a result, the highest temperature of the cylindrical cells 123 can be further reduced and variation in the temperature of the cylindrical cells 123 can be further suppressed.

Also, providing two endless belts increases the circulation force, which enables variation in the temperature distribution among the cylindrical cells 123 to be suppressed to a greater degree than it can be with the structure of the first example embodiment.

The arrangement of the endless belt 13 can be modified appropriately according to the distribution of the heat produced by the assembled battery 12. For example, the endless belt 13 may be arranged so as to surround some of the cylindrical cells 123 (such as the cylindrical cells 123 in the first and second rows). In this case, the arrangement of the endless belt 13 may be easily changed by changing the position of the rotating shaft 14.

In the foregoing example embodiments, the endless belt 13 is driven based on the temperature of the coolant that cools the assembled battery 12. Alternatively, however, the endless belt 13 may also be driven based on detection results from a temperature detection sensor that detects the temperature of coolant used to cool the engine.

Further, a tension roller that adjusts the tension of the endless belt 13 may also be provided.

In the second example embodiment, separate motors are provided for driving the first and second endless belts 131 and 132. Alternatively, however, the first and second endless belts 131 and 132 may be driven endlessly by dividing the driving force obtained from a single motor into two using a transmitting mechanism. This reduces the number of motors which in turn lowers costs.

In the foregoing example embodiments, the power supply apparatus 1 is arranged on the floor panel 22 underneath the passenger's seat. Alternatively, however, the power supply apparatus 1 may be arranged in another location such as between the driver's seat and the passenger's seat, or below the rear luggage compartment.

Also, the invention may be applied to an electrical double layer capacitor (power supply element) or a fuel cell (power supply element). The electrical double layer capacitor is structured such that a plurality of positive and negative poles are alternately stacked together with separators in between. In this electrical double layer capacitor, aluminum foil may be used as the collector, activate carbon may be used as positive electrode active material and negative electrode active material, and a porous membrane of polyethylene may be used as the separator, for example.

Also, the invention may also be applied to a square battery.

Further, a plurality of the power supply apparatuses 1 may be arranged parallel with one another in the longitudinal direction of the vehicle.

The power supply apparatus described above may be used as a power supply for driving a motor in an electric vehicle (EV), a hybrid vehicle (HEV), and a fuel cell vehicle (FCV), for example.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. (canceled)

2. The power supply apparatus according to claim 10, wherein the power supply element is arranged in a region surrounded by the endless belt.

3. The power supply apparatus according to claim 10, wherein a plurality of circulation portions are provided on the endless belt.

4. The power supply apparatus according to claim 10 further comprising:
temperature detecting device that detects a temperature of the coolant; and
a rotation controlling device that controls rotation of the endless belt by the rotating device based on a detection result from the temperature detecting devices.

5. The power supply apparatus according to claim 4, wherein the temperature detecting device includes a plurality of sensors that detect the temperature of the coolant are arranged in a plurality above the power supply element and below the power supply element within the power supply case; and the rotation controlling device endlessly rotates the endless belt by driving the rotating device when a temperature difference detected by the plurality of temperature detecting sensors that are arranged above the power supply element and below the power supply element within the power source case exceeds a predetermined value.

6. The power supply apparatus according to claim 5, wherein the predetermined value is 5° C.

7. The power supply apparatus according to claim 10, wherein the power supply element is formed of a plurality of power supply bodies.

8. The power supply apparatus according to claim 7, wherein the power supply element is formed by arranging the power supply bodies parallel with each other between support members; and a bearing portion of a rotating shaft of the rotating device is formed on the support members.

9. The power supply apparatus according to claim 10 further comprising:
a magnetic motor for rotating a rotating shaft from outside the power supply case.

10. A power supply apparatus comprising:
a power supply case;
a power supply element housed within the power supply case;
coolant that cools the power supply element that is housed within the power supply case;
an endless belt that is arranged in the coolant; and
a rotating device that endlessly rotates the endless belt.
